(19) United States
(12) Patent Application Publication
(10) Pub. No.: US 2003/0011839 A1
(43) Pub. Date: Jan. 16, 2003

(54) Performance of fiber transmission systems by transforming return-to-zero format to non-return-to-zero format in front of receiver

(76) Inventors: Anhui Liang, Marlborough, MA (US); Hiroyuki Toda, Sakai (JP); Maoki Suzuki, Suita (JP); Akira Hasegawa, Higashiyama-ku (JP)

Correspondence Address: Anhui Liang, Apt. 35, 110 Oak Rim Court, Las Gatos, CA, 95032, US

(21) Appl. No.: 09/900,861

(22) Filed: Jul. 10, 2001

(51) Int. Cl. H04J 14/02; H04B 10/04

(52) U.S. Cl. 359/124; 359/181

(57) ABSTRACT

There is enclosed a new optical signal detection scheme by means of converting transmitted optical RZ pulses to NRZ pulses. An optical fiber transmission system which uses the RZ format as the transmission format, and uses an optical pulse transformer to transform the optical RZ format to NRZ format in front of the receiver, then uses the NRZ format as the detection format at the receiver. One optical pulse transformer, which comprises an optical pre-amplifier, an optional optical filter and a span of normal dispersion fiber to transform high power optical RZ pulses to optical NRZ pulses by the combination effects of self-phase modulation and normal dispersion, is proposed and demonstrated. The tolerances for both the generalized timing jitter and amplitude jitter are increased significantly by using this invention. The Q factor is also increased by as much as 5.4 dB, which is a significant improvement on system performance.

### BACKGROUND OF THE INVENTION

The present invention relates to the transformation of Return to Zero (RZ) pulses to Non-Return to Zero (NRZ) pulses in front of the optical receiver in optical fiber communication systems with the purpose of increasing the tolerances of the generalized timing-jitter and the amplitude fluctuation.

In present optical fiber communication systems, people normally use optical amplifiers (i.e. Erbium-doped-fiber-amplifier (EDFA) or/and Raman amplifiers) as repeaters to compensate the fiber loss. The accumulated amplified spontaneous emission (ASE) noise generated by EDFA or/and Raman amplifiers can induce the optical signal to noise ratio (OSNR) degradation (i.e. intensity fluctuation increase) or the amplitude fluctuation. In front of the receiver (e.g. PIN or APD), a band-pass optical filter is normally used to filter out the ASE; at the receiver, the optical signal is converted to the electrical signal; after the receiver, the electrical signal is amplified by a high gain amplifier and then it is filtered by an electrical Bessel-Thompson low-pass filter which is used to reduce the electrical noise (See G. P. Agrawal, Fiber Optic Communication Systems, John Wiley & Sons, 1997, pp. 157). The low-pass filter shapes the voltage pulse. One of its main purposes is to reduce the noise without introducing much intersymbol interference (ISI). After passing the low pass filter, the electrical pulse spreads beyond the allocated bit slot. Such a spreading can interfere with the detection of neighboring bits, a phenomenon referred to as ISI. In addition to reduce the noise, the electrical Bessel-Thompson low-pass filter can also reduce the influence of the generalized timing jitter which means the pulse position randomly changes because of the noise and some other effects. The generalized timing jitter includes the Gordon-Haus timing jitter, and the pulse position variation induced by the pulse interaction, interchannel cross talk (including four-wave-mixing and cross-phase modulation), and polarization-mode-dispersion (PMD) etc. Where the Gordon-Haus timing jitter comes from the noise induced random nonlinear frequency shift when the dispersion is not zero (See J. P. Gordon, H. A. Haus, “Random walk of coherently amplified solitons in optical fibers” Opt. Lett., Vol. 11, pp.665-667, October, 1986.); the nonlinear pulse interaction between two neighboring pulses can also induce the generalized timing jitter (See. J. P. Gordon, “Interaction forces among solitons in optical fibers,” Opt. Lett., Vol. 8, pp.596-598, November 1983.); The cross-phase modulation between different channels of wavelength-division-multiplexing (WDM) can also induce the generalized timing jitter; PMD, which means the difference in group velocity for two orthogonal polarized modes, can also induce the pulse position shift, which varies randomly with the environment (e.g., temperature) change.

Displacement of pulse position at receiver caused by the generalized timing jitter can cause the bit error. The Bessel-Thompson low pass filter can broaden the pulse width and reduce the influence of the generalized timing jitter of received pulses (See B. Bakshi, et al, “Soliton interaction penalty reduction by receiver filtering,” IEEE Photon. Tech. Lett., 10, pp. 1042-1044 (1998)). The narrower the bandwidth of the low pass filter, the less the noise and the less serious influence of the generalized timing jitter, however the worse the ISI and the lower signal amplitude; the broader the low pass filter, the better the ISI and the higher signal amplitude, however, the more the noise and the more serious influence of the generalized timing jitter. The way to chose 3 dB bandwidth of the low pass filter is really an art to get a trade off between the noise, the generalized timing jitter, sensitivity and ISI. Typically, people choose the 3 dB bandwidth of low pass filter Δf=0.5-0.8 bit rate for both RZ and NRZ pulses (See B. Baksi, et al, “Soliton interaction penalty reduction by receiver filtering,” IEEE Photon. Tech. Lett., 10, pp. 1042-1044 (1998)).

This low pass filter technique is widely used in RZ optical communication systems. In this application, RZ pulses includes but not limited to the conventional soliton, dispersion managed (DM) soliton, non-chirped RZ, chirped RZ (CRZ), carrier-suppressed RZ (CS-RZ) and carrier-suppressed chirped RZ (CS-CRZ) formats. Where the conventional soliton takes advantage of fiber nonlinearity to compensate fiber dispersion in optical fiber systems with rough constant dispersion (A. Hasegawa, & Y. Kodama, Solitons in optical Communications, Claredon Press, Oxford, 1995); and the DM soliton takes advantage of fiber nonlinearity to compensate the average dispersion of fiber link consisted of positive and negative dispersion fibers; non-chirped RZ means that the RZ pulses without frequency chirping; CRZ means RZ pulses with frequency chirping; CS-RZ means the nearby non-chirped RZ pulses with opposite phase; CS-CRZ means the nearby chirped RZ pulses with opposite phase.

In high speed (e.g., the bit rate of per channel is 10 Gbit/s, 40 Gbit/s or even higher) optical transmission systems, normally RZ format has better transmission performance than NRZ format. However, in sense of detection at receiver, we found the NRZ format has better generalized timing jitter tolerance than the RZ format. To illustrate the reason simply, we assume that there are no ISI and noises for both ONE and ZERO rails and there is not the low pass filter at first, and the optimum decision threshold is about 0.5. When the RZ pulse format is used, the detection time is chosen at the average peak which is obtained by averaging millions of bits. The detected voltage of each RZ pulse at the specific detection time decreases if the pulse peak shifts from its average peak position because of the generalized timing jitter. When the detected voltage gets less than the optimum decision threshold 0.5, i.e. when the displacement of pulse peak position from the generalized timing jitter is larger than the half of the full-width-half-maximum (FWHM) pulse width, the bit error occurs. Similarly, for NRZ format, when the displacement the center of pulse position is larger than the half of FWHM pulse width, which is half of the bit period (e.g. 50 ps for a 10 Gbit/s channel), the bit error occurs. The FWHM pulse width of NRZ pulses is broader than that of RZ pulses, so the NRZ format has larger generalized timing jitter tolerance than the RZ format at the receiver. Although the low pass Bessel-Thompson filter are normally added after the photodetector to broaden the pulse width and thence to reduce the influence of the generalized timing jitter, unfortunately, the technique also induces the ISI. Therefore, it is better to use RZ as the transmission format and NRZ as the detection format (see M. Suzuki, H. Toda, A. Liang, & A. Hasegawa “Experimental Verification of Improvement of a phase margin in optical RZ receiver using Kerr nonlinearity in normal dispersion fibers,” ECOC'00, Munich, Germany, vol. 4, pp. 49-50, 2000). In all of existing systems, people always use same format (either NRZ or RZ) for both transmission and detection. In the present invention, we propose RZ as the transmission format and NRZ as the detection format by transforming RZ pulses to NRZ pulses in front of the photodetector. As an example, we first proposed and demonstrated a new technique to transform RZ pulses to NRZ pulses by utilizing Kerr nonlinearity in normal dispersion fibers, and the technique can reduce the influence of the generalized timing jitter without increasing the ISI, furthermore, the technique can also reduce the amplitude fluctuation significantly. Where the bit-error-rate (BER), which is defined as the probability of incorrect identification of a bit by the decision circuit of the receiver, is normally used to judge whether a transmission system has a good transmission performance or not, the lower the BER, the better the performance. Equivalently, people also often use the Q factor which relates to the BER by (See G. P. Agrawal, Fiber Optic Communication Systems, John Wiley & Sons, 1997, pp. 172)

$$B E R = \frac{1}{\sqrt{π}} {\int }_{\frac{Q}{\sqrt{2}}}^{∞} exp ( - \frac{{x}^{2}}{2} ) ⅆ x \qquad ( 1 )$$

The higher the Q factor, the lower the BER, the better the performance. In long haul and metro optical fiber systems, it is very important to improve the Q factor (i.e. to reduce the bit error rate).

As an example, we adapt the proposed technique to a 10 Gb/s soliton transmission system, our experimental result shows that our technique can increase the Q factor by 5.4 dB, which is significant improvement on system performance.

### SUMMARY OF THE INVENTION

The object of the present invention is improving system performance of fiber transmission systems by using the RZ format in the transmitter as the transmission format, transforming the RZ format to the NRZ format in front of the receiver, then finally detecting the NRZ format by the receiver. After the device to transform the RZ format to the NRZ format, there is normally a passband optical filter (or the device with similar function) to filter ASE noise, then the optical NRZ pulses can be converted to electrical signal at the photodetector. After the photodetector, there is a high gain electrical amplifier. In our invention, the low pass filter after the high gain electrical amplifier is only an option and is not a requirement. Our invention can both increase the generalized timing jitter tolerance and reduce amplitude fluctuation and the ISI influence, i.e. it enables us to have larger amplitude and phase margins.

As an important example, we proposed and experimentally demonstrated one method to transform RZ pulses to NRZ pulses by using Kerr effect in normal dispersion fibers (See M. Suzuki, H. Toda, A. Liang, & A. Hasegawa, “experimental Verification of Improvement of a phase margin in optical RZ receiver using Kerr nonlinearity in normal dispersion fibers,” ECOC'00, Munich, Germany, vol. 4, pp. 49-50, 2000.). When high power RZ optical pulses propagate along the normal dispersion fibers with Kerr effect, their temporal waveforms change to a rectangular-like profile with steep leading and trailing edges (See G. P. Agrawal, Nonlinear Fiber Optics, Academic Press, pp. 106-111, 1995). Our experiment demonstrated that the technique can both increase the generalized timing jitter tolerance and reduce the amplitude fluctuation and the ISI influence, so it enables us to have larger amplitude and phase margins (See M. Suzuki, H. Toda, A. Liang, & A. Hasegawa, “Experimental Verification of Improvement of a phase margin in optical RZ receiver using Kerr nonlinearity in normal dispersion fibers,” ECOC'00, Munich, Germany, vol. 4, pp. 49-50, 2000.). Our experiment also showed that our invention can improve the Q factor by as large as 5.4 dB compared to conventional RZ detection scheme which detects RZ pulses directly and use low pass electrical filter to filter noise (See M. Suzuld, H. Toda, A. Liang, & A. Hasegawa, “Improvement of Amplitude and Phase Margins in an RZ Optical Receiver using Kerr Nonlinearity in Normal Dispersion Fiber”, IEEE Photonics Technol. Lett., to be published, 2001; M. Suzuki and H. Toda, “Q-factor improvement in a jitter limited optical RZ system using nonlinearity of normal dispersion fiber placed at receiver”, OFC'2001, Anaheim, paper WH3, 2001). In long haul systems, there are two popular techniques to improve the Q factor, where one is the forward-error-correction (FEC) technique and another is the Raman amplifier technique. Typically, the FEC technique can increase Q by about 5-6 dB. However, it requires about 7% or higher overhead in transmission rate and is difficult to implant in 40 Gbit/s systems because of the difficulty to make high electrical bandwidth transmitters and receivers. The Raman amplifier technique can improve Q by 2-5 dB typically. Therefore, the technique in this invention is an important alternative to the FEC and the Raman amplifier techniques in long haul systems. The new technique is more powerful than the typical Raman amplifier technique and is as powerful as the FEC technique but with significantly reduced complications and without requiring the transmission overhead. Therefore, our new technique is the third technical breakthrough after FEC and Raman amplifier in long haul systems. By using this technique, all influences of the generalized timing jitter (induced from the Gordon-Haus timing jitter, PMD, cross-phase modulation, four-wave-mixing and pulse interaction etc.), the amplitude fluctuation and the ISI are reduced significantly. This invention is especially useful in 40 Gbit/s long haul and ultra-long haul systems and 10 Gbit/s ultra-long haul systems, where the generalized timing jitter induced by PMD and cross-phase modulations are the major degrading factors. (Although PMD compensators can reduce the PMD induced timing jitter, they are complex, expensive and difficult to be made. There are no commercial available 40 Gbit/s PMD compensator now, although there are commercial available 10 Gbit/s PMD compensators but those only for single channel. On the contrary, this technique is very simple, and needs only one EDFA, normal dispersion fiber and (optional) optical filter.)

In front of receivers of many existing optical fiber transmission systems, there are already the normal dispersion fibers as post-dispersion compensation units and the pre-amplifiers EDFA with optical filters, in this case, our invention even does not need to add more components, the only thing we need to do is to change the pre-amplifier EDFA to a relative high power version (e.g. 15-19 dBm/channel or higher), and to relocate it to a suitable location in the post-dispersion compensation fiber unit.

### BRIEF DESCRIPTION OF THE DRAWING

FIG. 1 illustrates that when the timing jitter is larger than the half of FWHM of RZ pulses, a bit error occurs. To illustrate the ideas simply, we assume no electrical filter; and no amplitude noise.

FIG. 2 illustrates that when the timing jitter is larger than the half of FWHM of NRZ pulses, a bit error occurs. To illustrate the ideas simply, we assume no electrical filter, and no amplitude noise.

FIG. 3 illustrates one WDM transmission system which uses RZ format as the transmission format, then transforms RZ format to NRZ format, and finally uses NRZ as the detection format.

FIG. 4 illustrates a transformer receiver unit which includes a single channel optical pulse transformer, which transforms optical RZ pulses to NRZ pulses, and a receiver.

FIG. 5 illustrates a transformer receiver unit which includes a multiple channels optical pulse transformer, which transforms optical RZ pulses to NRZ pulses, and receivers.

FIG. 6 illustrates one optical pulse transformer consisted of one amplifier, one (optional) bandpass filter and one span of normal dispersion fiber.

FIG. 7 illustrates one optical RZ pulse evolves NRZ-like pulse when propagating along the normal dispersion fiber with Kerr nonlinearity.

FIG. 8 The Schematic diagram of the proposed transformer receiver unit used in our experiment. NDF stands for normal dispersion fiber.

FIG. 9 The Eye diagrams of the transmitted 10 Gbit/s solitons at 16,000 km observed (a) without electrical lowpass filter, (b) with a lowpass filter with 7.5 GHz bandwidth, and (c) with the proposed method. Horizontal axis: 25 ps/div.

FIG. 10 Measured threshold voltage and detection time of the BER detector where BER equals 10⁻⁷.

FIG. 11 Measured BER at 12,000 km transmission versus the threshold voltage. The detection time was adjusted to minimize the BER for both cases.

### DETAILED DESCRIPTION OF THE INVENTION

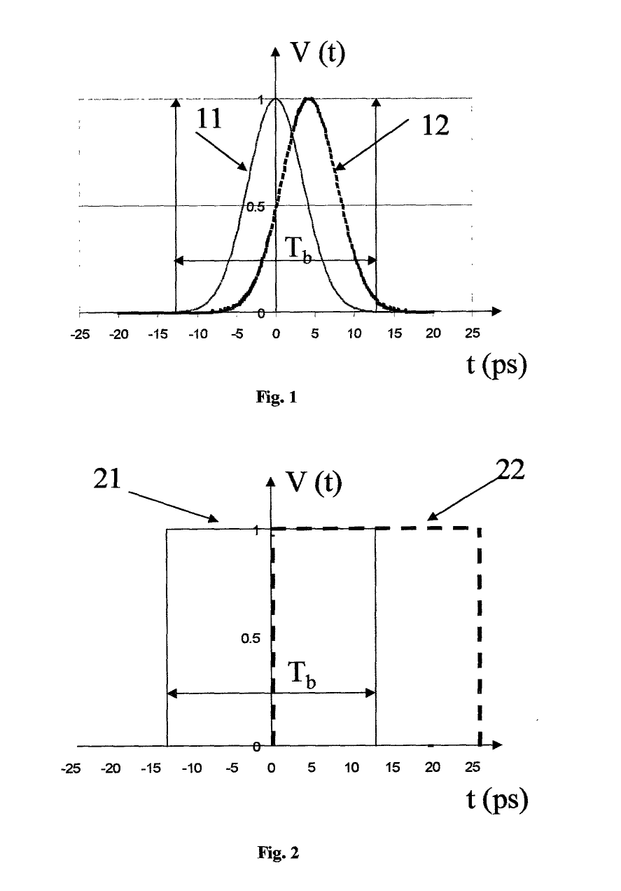

To illustrate the idea of that the NRZ format has larger generalized timing jitter tolerance than the RZ format, we first simply assume no electrical filter after the photodetector, and no amplitude noise. In this case, we can assume the decision threshold is 0.5 times of pulse peak voltage approximately. Here we take a 40 Gbit/s system as an example, we assume the bit period T_{b} is 25 ps for both RZ and NRZ formats as shown in FIGS. 1 and 2. FIG. 1 shows that when the generalized timing jitter is larger than the half of FWHW pulse width of RZ pulses T_{FWHM,RZ}, the voltage at the decision instant (ie., 0 ps) will be less than the decision threshold 0.5, then there is a bit error. Where the solid curve 11 is the average RZ pulse whose peak is located at 0 ps, and the dashed curve 12 is the instantaneous pulse whose peak shifts to the half of T_{FWHM, RZ} because of the generalized timing jitter induced by the Gordon-Haus timing jitter, PMD, cross-phase modulation, four-wave-mixing or pulse interaction etc. FIG. 2 shows that if the generalized timing jitter is larger than the half of FWHW pulse width of NRZ pulses T_{FWHM, NRZ}, there is a bit error. Where the sold curve 21 is the average NRZ pulse whose peak is located at 0 ps, and the dashed curve 22 is the instantaneous pulse whose peak shifts to the half of T_{FWHM, NRZ}=25 ps because of the generalized timing jitter. To avoid ISI penalty, T_{FWHM, RZ} should be chosen to be less than the bit period T_{b} ie. T_{FWHM, NRZ}, therefore the NRZ format has larger generalized timing jitter tolerance than the RZ format.

When a low pass electrical filter is put after the photodetector, RZ pulses can broaden. Even in this case, the broadened FWHM pulse width T_{FWHM, RZ} still should be less than the bit period (i.e., the FWHM pulse width of NRZ pulses without filter) to avoid too large ISI penalty. Therefore, in this case, NRZ format still has larger generalized timing jitter tolerance than the RZ format.

It is noted that the NRZ pulses may not be the square pulses strictly both in optical domain (before the photodetector) and the electrical domain (after the photodetector), in practical systems, the electrical NRZ pulses (after the photodetector) are normally with the leading edge and trailing edge because of the limited response time of the photodetector. In practical systems, the FWHM pulse width of NRZ pulses can also be shorter than the bit period in some degrees both before and right after the photodetector, and we call this kind pulses as NRZ-like pulses.

In high speed (10 Gbit/s, 40 Gbit/s and higher) systems (especially in long haul ultralong haul undersea and terrestrial systems), RZ formats (including dispersion managed soliton, CRZ, conventional soliton, non-chirped RZ, carrier-suppressed RZ, carrier-suppressed CRZ etc.) have been widely used in practical systems, because RZ formats normally have better transmission performance than NRZ format.

In this invention, we use RZ format as the transmission format because of their good transmission performance, then we transform the RZ formats to NRZ format in front of photodetector, finally we use the NRZ format as the detection format because of its excellent detection performance. Where we call the device, which transforms the optical RZ pulses to optical NRZ pulses, as an optical pulse transformer. In this invention, the meaning of using RZ format as the transmission format is that the transmitter generates optical RZ pulses, the optical RZ pulses may keep RZ pulse shapes or may become complex pulse shapes (non-RZ-like shapes) in the (optional) pre-compensation-unit, transmission link and the (optional) post-dispersion unit, at the end of the transmission link or the (optional) post-compensation-unit, the optical pulses return back to the RZ format.

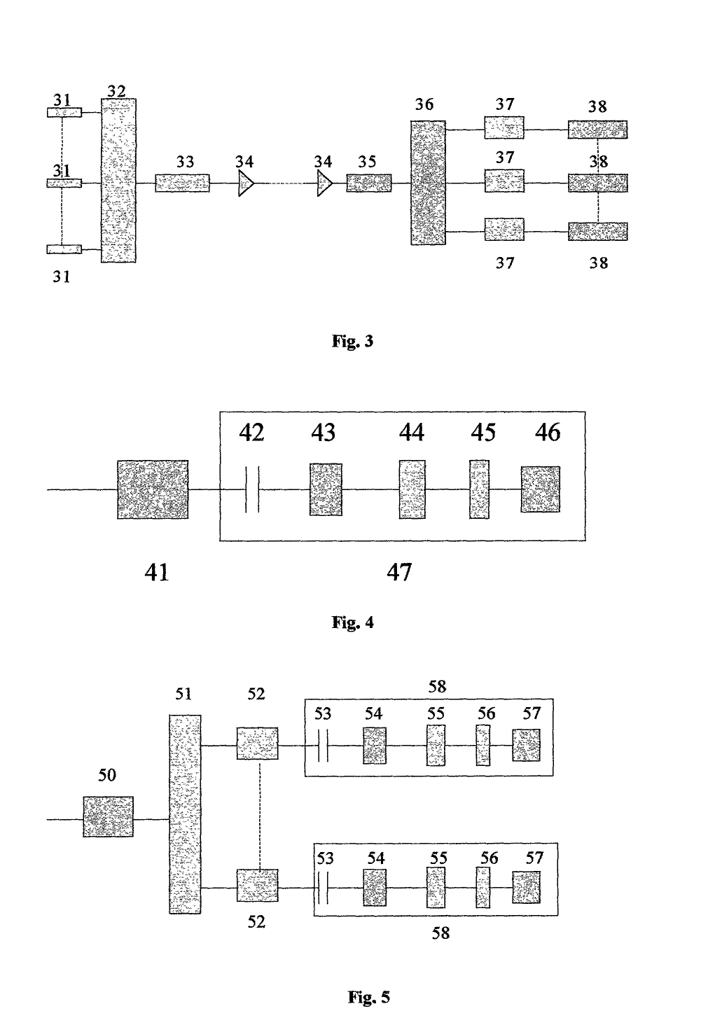

FIG. 3 illustrates one WDM transmission system using the invention. Where the each transmitter 31, which normally includes a laser diode, intensity modulator, data modulator and (optional) phase modulator etc. (or which may be a direct modulated laser diode), generates a train of optical RZ pulses with individual wavelength channel, then the WDM multiplexer (or fiber coupler) 32 combines optical RZ pulses of multiple wavelength channels to the same fiber. The optical RZ pulses may pass through a pre-dispersion compensation unit 33, which is optional, then they enter into the optical amplifier 34 of the transmission link. The pre-dispersion compensation unit 33 is used to compensate the dispersion of transmission link. The pre-dispersion compensation unit can be put after WDM multiplexer 32 to compensate the dispersion of multiple channels simultaneously, and it can also be put before the WDM multiplexer 32 to compensate the dispersion of the individual channel separately The optical RZ pulses may become complex shapes after pre-dispersion compensation unit 33, and they can also evolve to complex pulse shape in the transmission link. (In this case, we still call it to use RZ format as the transmission format following the normal terminology). If there is not the pre-dispersion compensation unit 33, the optical RZ pulses directly enter into the optical amplifier 34 of the transmission link. Optical pulses transmit over the transmission link consisted of fiber spans and optical amplifiers 34. After the transmission link, optical pulses pass through the first post-dispersion compensation unit 35, which is optional, to compensate the dispersion of multiple channels simultaneously. After the first post-dispersion compensation unit 35, the total channels are demultiplexed by the WDM demultiplexer (or couplers with filters) 36 to individual channels or sub-group of channels. The second post-dispersion unit 37, which is optional, compensates the dispersion of individual channels or sub-group of channels. Finally, in the transformer receiver unit 38 of the invention, the optical RZ pulses of individual channel or of sub-group of channels are transformed into NRZ pulses and detected by the receiver.

FIG. 4 shows the detail configuration of the novel transformer receiver unit 38 (of FIG. 3) for single channel, which includes the optical pulse transformer 41 and the receiver 47. Where the receiver 47 includes an (optional) optical bandpass filter 42, a photodetector 43, a high gain amplifier 44 (e.g., trans-impedance amplifier), an (optional) low pass Bessel-Thompson filter 45, and the decision circuit 46. Where the optical pulse transformer 41 transforms optical RZ pulses to NRZ pulses, which pass through the (optional) optical bandpass filter 42 later to filter ASE noise generated by optical amplifiers. The filtered NRZ optical pulses are converted to the electrical NRZ pulses by the photodetector 43, and then the electrical NRZ pulses are amplified by the high gain amplifier 44. Then the amplified NRZ pulses pass through the low pass Bessel-Thompson filter 45, which is optional. Even there is the low pass Bessel-Thompson filter 45, its optimal bandwidth for NRZ pulses in our invention is normally different from that for RZ pulses in conventional receivers. Finally the electrical pulses are detected by the decision circuit 46.

In some high speed systems (e.g., 40 Gbit/s per channel), there are two sub-channels (e.g. 20 Gbit/s per sub-channel) with orthogonal polarizations for one wavelength channel, and this kind of system is often called as the optical-time-division-multiplexing (OTDM) system. At the receiver, there is an optical polarization beam splitter (PBS) to split the one wavelength channel (e.g. 40 Gbit/s) to two sub-channels (e.g., 20 Gbit/s). In this OTDM system, our optical pulse transformer can be put either after the PBS to transform the two sub-channels (e.g., 20 Gbit/s) separately or before the PBS to transform one wavelength channel (e.g., 40 Gbit/s) wholly.

FIG. 5 shows the detail configuration of the novel transformer receiver unit 38 (of FIG. 3) for a sub-group of channels, which includes the optical pulse transformer 50, the WDM demultiplexer 51 (or couplers with filter), the (optional) post-dispersion compensation-unit 52 and the receiver 58. The main difference between FIG. 4 and FIG. 5 is that the pulse transformer 41 only transforms optical RZ pulses of single channel to optical NRZ pulses, but the common pulse transformer 50 transforms optical RZ pulses of a sub-group of channels to optical NRZ pulses. Although the channel spacing of the WDM demultiplexer 51 can be the same as the channel spacing in transmission link, to reduce the potential cross talks in the optical pulse transformer 50 and to reduce the cost, it is better to choose its channel spacing several times (e.g. 4 or 8 times) larger than the channel spacing in transmission link. After the optical NRZ pulses are demultiplexed by the WDM demultiplexer 51 (or coupler with filter), they pass through the (optional) post-dispersion compensation-unit 52, which compensates the dispersion of individual channel. After that, the optical RZ pulses pass through an (optional) optical bandpass filter 53 to filter ASE noise generated by optical amplifiers. The filtered optical NRZ pulses are converted to the electrical NRZ pulses by photodetector 54, and then the electrical NRZ pulses are amplified by a high gain amplifier 55 (e.g., trans-impedance amplifier). Then the amplified NRZ pulses pass through a low pass Bessel-Thompson filter 56, which is optional. Even with the low pass Bessel-Thompson filter 56, its optimal bandwidth for NRZ pulses in our invention is normally different from that for RZ pulses in conventional receivers. Finally the electrical pulses are detected by the decision circuit 57. To compare with the configuration of FIG. 4, the configuration of FIG. 5 is less cost because fewer optical pulse transformer are needed.

Although FIGS. 3-5 only shows the point to point WDM transmission systems, our invention can be used in mesh networks and ring networks as well. In mesh and ring networks, there may be optical switches, optical channel add-drop multiplexers, optical cross-connect, and routers etc. What we need to do is just to insert an optical pulse transformer in front of photodetector to transform optical RZ pulses to NRZ pulses.

The invention is suitable for both WDM systems and single channel systems.

The invention can be used in both undersea and terrestrial systems, and it is especially useful in long haul and ultra long haul high speed (e.g., 10 Gbit/s per channel 40 Gbit/s per channel and higher) systems, where the generalized timing jitter (induced by the Gordon-Haus timing jitter, PMD, pulse interaction, cross-phase modulation, and four-wave-mixing etc.) have a large system impairment.

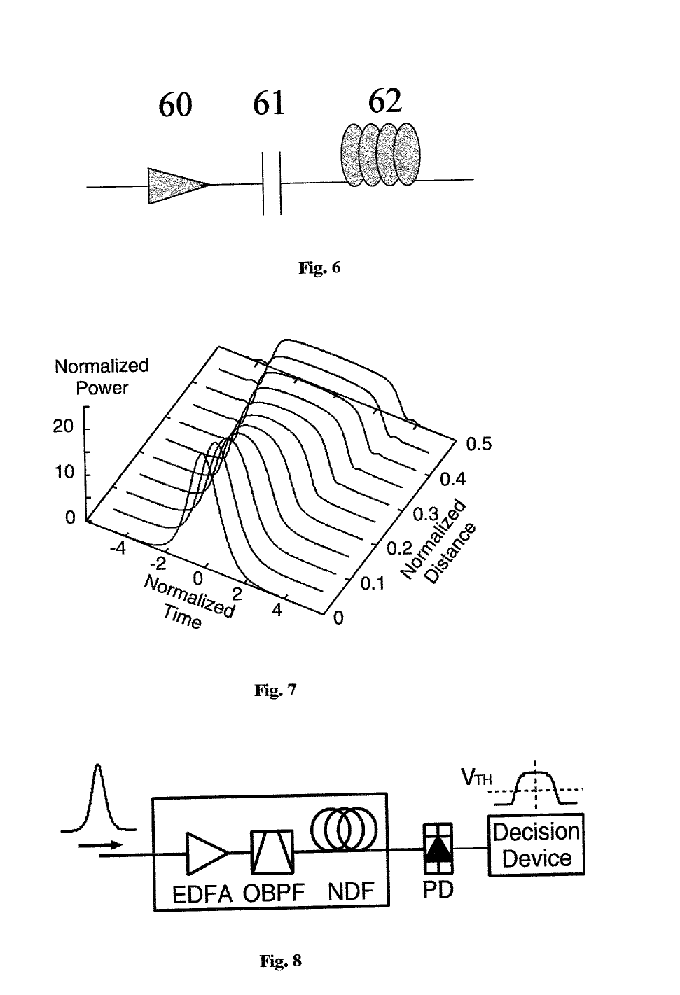

As a most important example for the optical pulse transformer in FIGS. 4 and 5, FIG. 6 shows an optical pulse transformer which is consisted of a pre-amplifier 60, an (optional) optical filter 61 and a span of normal dispersion fiber 62 (See M. Suzuki, H. Toda, A. Liang, & A. Hasegawa “Experimental Verification of Improvement of a phase margin in optical RZ receiver using Kerr nonlinearity in normal dispersion fibers,” ECOC'00, Munich, Germany, vol. 4, pp. 49-50, 2000.). Where the pre-amplifier 60, which can be an EDFA, Raman or semiconductor amplifier, amplifies an optical RZ pulse to a relative high power level, the (optional) optical filter 61 filters the ASE noise from the optical amplifier. When the high power RZ optical pulse propagates along normal dispersion fiber 61, its temporal waveform changes to a NRZ-like pulse by the effects of group velocity dispersion and Kerr nonlinearity (See G. P. Agrawal, Nonlinear Fiber Optics, Academic Press, pp. 106-111, 1995). The configuration of FIG. 6 can transform not only single channel RZ pulses to NRZ pulses, but also multiple channels (e.g. 4 or 8) RZ pulses to multiple channels NRZ pulses simultaneously (where the channel spacing should be large enough to reduce the cross talks between different channels, e.g., we can do this by picking up one channel from every four or eight channels.). In this case, we do not need one preamplifier and one span (e.g. several tens of km) of normal dispersion fibers for each channel, we can share same preamplifier and same span of normal dispersion fibers for multiple wavelength channels and it will reduce the cost and complex of systems significantly.

FIG. 7 shows one optical RZ pulse evolves NRZ-like pulse when propagating along the normal dispersion fiber with Kerr nonlinearity. Where the normalized time=t/t₀, the normalized distance=z/z₀, and the normalized power N(t)=o(t)/P₀ with t the time, z the distance, p(t) the intensity profile, and

$${t}_{0} = \frac{{T}_{F WH M}}{1.76} , {z}_{0} = 0.322 \frac{{π}^{2} {c}^{2} {T}_{FWHM}^{2}}{\vert D \vert λ} , {P}_{0} = \frac{n c λ {A}_{eff}}{16 π {z}_{0} {n}_{2}} \times {10}^{- 7}$$

and T_{FWHM} the FWHM pulse width of the RZ pulse, c the light speed, D the dispersion of fiber, λ the wavelength, n the refractive index of fiber, n₂ the nonlinear-index coefficient, and A_{eff} the effective core area. When the normalized power is large, it will induce frequency chirp imposed on the pulse because of the strong self-phase modulation. In the case of normal dispersion the pulse becomes nearly rectangular with relatively sharp leading and trailing edges and is accompanied by a linear chirp across its entire width. Not only the pulse shape changes to the square shape (i.e. NRZ format), but also the optical spectrum changes to the square shape.

FIG. 8 shows the schematic diagram in our experiment for the proposed transformer receiver unit, which is constructed by an EDFA with about 15-19 dBm of output power, an optical bandpass filter (OBPF) which reduces the ASE, a span (about 20 km) of normal dispersion fiber (NDF), a photodetector (PD) and a decision device. The launched power and NDF length are optimized by the results of numerical simulation. If the transmission system utilizes optical solitons, the normal dispersion of this NDF will have extra good effects in reducing the Gordon-Haus timing jitter accumulated in the transmission fiber of anomalous dispersion. In the receivers of many transmission systems, there have already had preamplifier EDFA in front of the photodetector and the normal dispersion fiber as the post-dispersion compensation unit, so it is very easy to change these existing systems to our proposed transformer receiver unit by simply increasing the output power of EDFA and moving it to the right position in the normal dispersion fiber of the post-dispersion compensation unit.

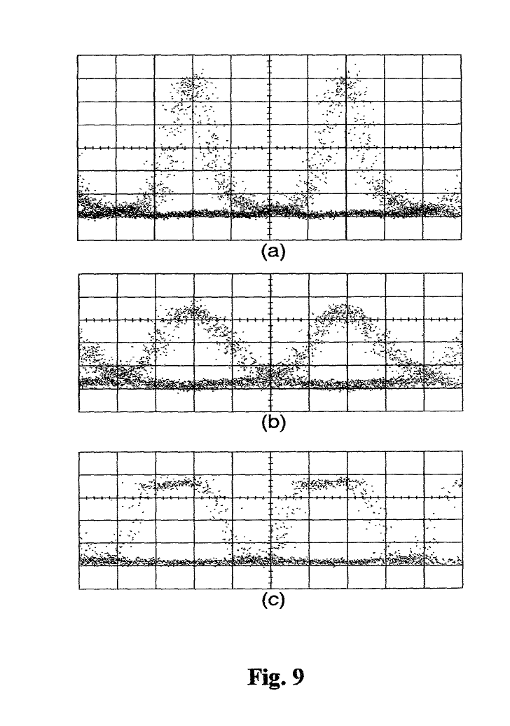

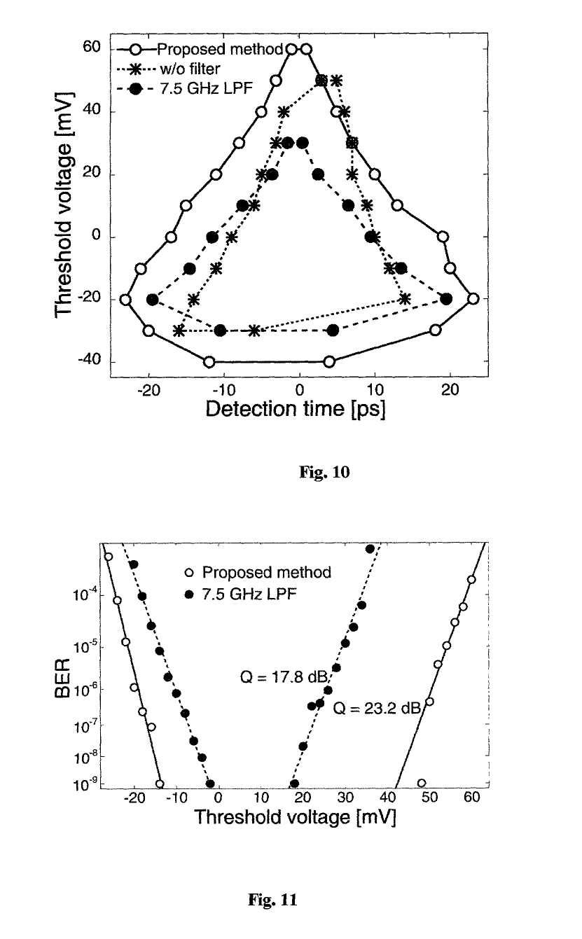

We have carried out 10 Gbit/s soliton transmission experiment in a sliding frequency recirculating loop in order to compare the characteristics of the proposed method and the conventional RZ optical receiver. When the pulses are detected with the conventional scheme, the EDFA and NDF are removed and the electrical lowpass filter is inserted after the photodiode. FIG. 9 shows the eye diagrams of the transmitted pulses at 16,000 km observed (a) without electrical lowpass filter, (b) with a lowpass filter with 7.5 GHz bandwidth, (which is typically used in present 10 Gbit/s systems) and (c) with the proposed method, respectively. The electrical bandwidth of the photodiode (PD) and the sampling oscilloscope are 32 and 50 GHz, respectively. The average optical power to the PD and the vertical scale of the sampling oscilloscope are kept equal for all the measurements. We can see in FIG. 9(b) that the pulse is broadened by the lowpass filter. However, the amplitude jitter on “0” signals was increased because of the ISI. As shown in FIG. 9(c), the waveform of the RZ pulses are changed to a NRZ-like format by utilizing normal dispersion and self-phase modulation in the NDF, while the amplitude of the pulses is nearly the same with in the case of FIG. 9(b). The eye opening is wider than that detected with the 7.5-GHz lowpass filter. In addition, the amplitude jitters on both “1” and “0” signals at the center portion of pulses are remarkably small. One of the reasons may be the reduced ISI in proposed scheme and reduced amplitude fluctuation for the pulses transmission in normal dispersion fiber. Next, we measured the threshold voltage and the detection time of the BER detector where BER equals 10⁷. We optimized the state of polarization for all the measurements with the polarization controller (PC) in the loop. FIG. 10 shows the result. The obtained amplitude margin detected with the proposed method was 100 mV, which was 70% larger than that with the conventional method. The improvement of the phase margin is about 18%. FIG. 11 shows the measured BER versus the threshold voltage of the BER detector at 12,000 km transmission. In this case, we adjusted the detection time to minimize the BER for all the measurements. The averaged optical power to the PD is different from the case of FIG. 10. When the transmitted pulses are detected with the 7.5-GHz lowpass filter, the amplitude margin at the BER of 10⁻⁹ is 19.3 mV. On the contrary, when the transmitted pulses are detected with the proposed method, the margin is 56.0 mV, which is about 3 times larger than that of the conventional RZ receiver using the 7.5-GHz lowpass filter. The estimated Q factor is 17.8 dB for the low pass filter and 23.2 dB for the proposed method respectively (See M. Suzuki, H. Toda, A. Liang, & A. Hasegawa, “Improvement of Amplitude and Phase Margins in an RZ Optical Receiver using Kerr Nonlinearity in Normal Dispersion Fiber”, IEEE Photonics Technol. Lett., to be published, 2001; M. Suzuki and H. Toda, “Q-factor improvement in a jitter limited optical RZ system using nonlinearity of normal dispersion fiber placed at receiver”, OFC'2001, Anaheim, paper WH3, 2001). Therefore, our invention can increase Q by as large as 5.4 dB, which is very significant improvement. In practical systems, even 1 dB of Q improvement has been thought to be significant. To our knowledge, only the forward-error correction and the Raman amplifier techniques can increase Q by more than 5 dB. The combination of the novel technique and the Bessel-Thompson filter may even improve the result further.

Although we demonstrated the EDFA as the preamplifier to transform the RZ pulses to NRZ pulses, both distributed and discrete Raman amplifiers can be used as the same purpose. In that case, the distributed Raman amplifier should be put after the NDF, but the discrete Raman amplifier can be put either after or before the NDF.

When there is frequency chirping for the optical RZ pulses after the transmission link or after the post dispersion compensation unit, we still can use the configuration of FIG. 6 to transfer optical RZ pulses to optical NRZ pulses.

The invention is useful for both noise-limited and generalized timing jitter-limited systems.

The present invention is not limited to the above-described embodiments. Numerous modifications and variations of the present invention are possible in light of the sprit of the present invention, and they are not excluded from the scope of the present invention.

We claim:

1. A method to improve the system performance of an optical fiber transmission system by using
the optical RZ format as the transmission format, transferring the RZ format to the NRZ (or NRZ-like) format in front of the receiver, then detecting the NRZ (or NRZ-like) format at the receiver.

2. The method of claim 1 wherein said the RZ format is generated in the transmitter and enter into the pre-dispersion compensation unit.

3. The method of claim 1 wherein said the RZ format is generated in the transmitter and then enter into transmission link directly.

4. The method of claim 1 wherein said the optical fiber transmission system can be the noise limited system or/and the generalized timing-jitter limited systems.

5. The method of claim 1 wherein said optical RZ pulse can be but not limited to be the format of dispersion managed soliton, conventional soliton, chirped-RZ, non-chirped RZ, carrier-suppressed RZ, and carrier-suppressed chirped-RZ etc.

6. The method of claim 1 can increase the tolerance of both the amplitude fluctuation and the generalized timing jitter which includes the Gordon-Haus timing jitter, and the pulse position variation induced by the pulse interaction, interchannel cross talks (including four-wave-mixing and cross-phase modulation), and polarization-mode-dispersion (PMD) etc.

7. An optical fiber transmission system comprising at least one optical transmitter to generate optical RZ pulses, (optional) WDM multiplexers or couplers, (optional) pre-dispersion compensation units, one transmission link consisted of fiber spans and amplifiers, post-dispersion compensation units, WDM demultiplexer or couplers, (optional) optical pulse transformers which transfers optical RZ pulses to optical NRZ (or NRZ-like) pulses, and receivers to detect optical NRZ (or NRZ-like) pulses.

8. The optical fiber transmission system of claim 7 wherein said optical RZ pulses can be but not limited to be the format of dispersion managed soliton, conventional soliton, chirped-RZ, non-chirped RZ, carrier-suppressed RZ, and carrier-suppressed chirped-RZ etc.

9. The optical fiber transmission system of claim 7 wherein said optical RZ pulses of each wavelength channel can have either two orthogonal polarization sub-channels or two co-polarization sub-channels at same wavelength.

10. The optical fiber transmission system of claim 7 wherein said optical RZ pulses is generated in the transmitter and enter into the pre-dispersion compensation unit.

11. The optical fiber transmission system of claim 7 wherein said the RZ pulses are generated in the transmitter and then enter into transmission link directly.

12. The optical fiber transmission system of claim 7 can be the noise limited system or/and the generalized timing-jitter limited systems.

13. The optical fiber transmission system of claim 7 can be point to point systems, ring networks or mesh networks.

14. The optical fiber transmission system of claim 7 can be WDM system or single-wavelength system.

15. The optical fiber transmission system of claim 7 wherein said optical pulse transformers can transform either the optical RZ pulses of single wavelength channel or multiple wavelength channels to NRZ pulses.

16. The optical fiber transmission system of claim 7 wherein said the optical RZ pulses in front of said the optical pulse transformers can be either with or without frequency chirp.

17. The optical fiber transmission system of claim 7 wherein said the receiver includes an optional optical filter, a photodetector, a high-gain electrical amplifier, an (optional) low pass electrical filter and a decision circuit.

18. An optical fiber transmission system of claim 7 wherein said the optical pulse transformers comprising
an optical pre-amplifier to amplifier the RZ pulses, an optional optical filter to filter ASE noise and a span of normal dispersion fiber to transform high power optical RZ pulses to optical NRZ pulses by the combination effects of self-phase modulation and normal dispersion.
